(19) United States
(12) Patent Application Publication
(10) Pub. No.: US 2008/0016975 A1
(43) Pub. Date: Jan. 24, 2008

(54) Power transmission system for vehicle

(75) Inventors: Kazuaki Nakamura, Toyota-shi (JP); Kazuyuki Watanabe, Anjou-shi (JP); Takeshi Ishiwada, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA

(21) Appl. No.: 11/826,137

(22) Filed: Jul. 12, 2007

(30) Foreign Application Priority Data
Jul. 19, 2006 (JP) 2006-197485

(51) Int. Cl. F16H 57/04

(52) U.S. Cl. 74/467

(57) ABSTRACT

A power transmission system for a vehicle is provided, including: a housing that can reserve oil therein; and a rotational member rotatably supported within the housing, with a surface of the rotational member being partly contactable with a surface of the oil reserved in the housing, in which the surface of the rotational member partly contactable with the oil surface includes a non-contact surface that is not in contact with any power transmission members, the non-contact surface having an oil repellent section. When the surface of the rotational member contacts the oil surface, the oil repellent section repels the oil quickly. Therefore, the amount of oil, which adheres to and rotates with the rotational member agitating the oil, decreases. This reduces oil heat generation and rotational resistance to the rotational member.

### INCORPORATION BY REFERENCE

The disclosure of Japanese Patent Applications No. 2006-197485 filed on Jul. 19, 2006, including the specification, drawings and abstract is incorporated herein by reference in its entirety.

### BACKGROUND OF THE INVENTION

1. Field of the Invention

The present invention relates to a power transmission system for a vehicle having a rotational member that is driven by a power source and can contact oil reserved within the transmission system, and more particularly relates to reduction in rotational resistance to the rotational member due to contact with the oil and reduction in oil heat generation.

2. Description of the Related Art

A large number of rotational members driven by the power source, such as engine, are provided in the power transmission system mounted in a vehicle. They include a clutch drum and gears. Oil, reserved at a vertical bottom in the power transmission system, is used as lubricant for some elements. Recent trend shows that the size of such power transmission system itself is reduced in comparison with conventional power transmission systems, whereas a clutch drum of the transmission in the power transmission system has an increased diameter in order to increase torque transmission capacity. This results in a shorter distance between the outer peripheries of the rotational members, such as clutch drum, and the surface of the reserved oil. As the oil temperature becomes relatively higher, the oil viscosity becomes lower, which increases the amount of the oil reserved. Thus, the rotational members are more likely to come into contact with the oil surface. An automatic transmission, disclosed in JP-A-2002-161973, has such configuration as described above, in which the clutch drum and the transmission case are slightly spaced apart from each other, rendering the automatic transmission compact.

The automatic transmission of the related art, disclosed in JP-A-2002-161973, may cause energy loss due to heat from oil agitated by the clutch drum as well as due to increased rotational resistance to the clutch drum because of contact with oil. Particularly, with a recent move toward high-powered engines, the rotational members rotate at high speeds. This increases not only the rotational resistance caused by interference between the rotational members and oil, but also oil heat generation, which may provide the vehicle with lower fuel economy.

### SUMMARY OF THE INVENTION

The present invention has been developed based on the background described above, and an object of the invention is therefore to provide a power transmission system for a vehicle having a rotational member that is driven by a power source and can contact oil reserved in the transmission system, the rotational member being designed to reduce rotational resistance due to contact with the oil and oil heat generation.

In accordance with an aspect of the invention, the power transmission system for a vehicle is provided, including: a housing that can reserve oil therein; and a rotational member rotatably supported within the housing, with a surface of the rotational member being partly contactable with a surface of the oil reserved in the housing, in which the surface of the rotational member partly contactable with the oil surface includes a non-contact surface that is not in contact with any power transmission members, the non-contact surface having an oil repellent section.

According to the above aspect of the power transmission system for a vehicle, the rotational member has the oil repellent section. Thus, when the surface of the rotational member contacts the oil surface, the oil repellent section repels the oil quickly. Therefore, the amount of oil, which adheres to and rotates with the rotational member agitating the oil, decreases. This reduces oil heat generation and rotational resistance to the rotational member.

### BRIEF DESCRIPTION OF THE DRAWINGS

The features, advantages thereof, and technical and industrial significance of this invention will be better understood by reading the following detailed description of preferred embodiments of the invention, when considered in connection with the accompanying drawings, in which:

FIG. 1 is a schematic diagram of an automatic transmission in a power transmission system for a vehicle according to one embodiment of the invention.

FIG. 2 lists various operating conditions of friction engagement elements or friction engagement devices when each of the gears is established in the automatic transmission of FIG. 1.

FIG. 3 is a sectional view illustrating an essential part of a second transmission unit included in the automatic transmission.

### DETAILED DESCRIPTION OF THE PREFERRED EMBODIMENTS

In the following description and the accompanying drawings, the present invention will be described in more detail with reference to exemplary embodiments.

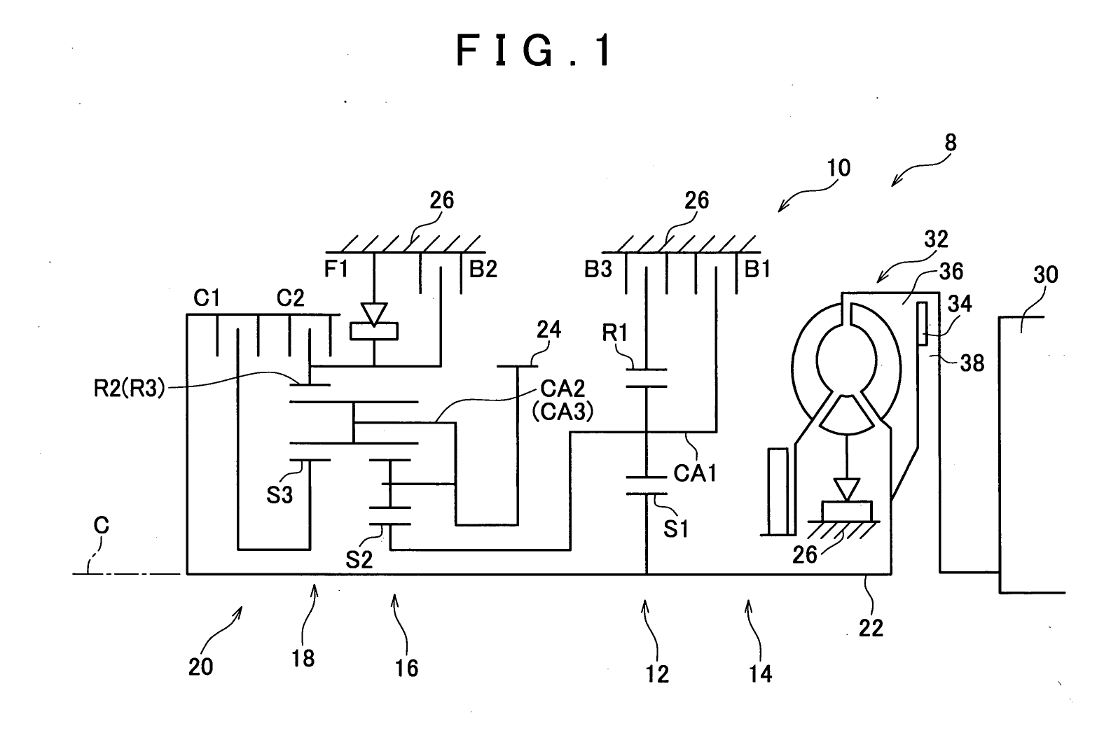

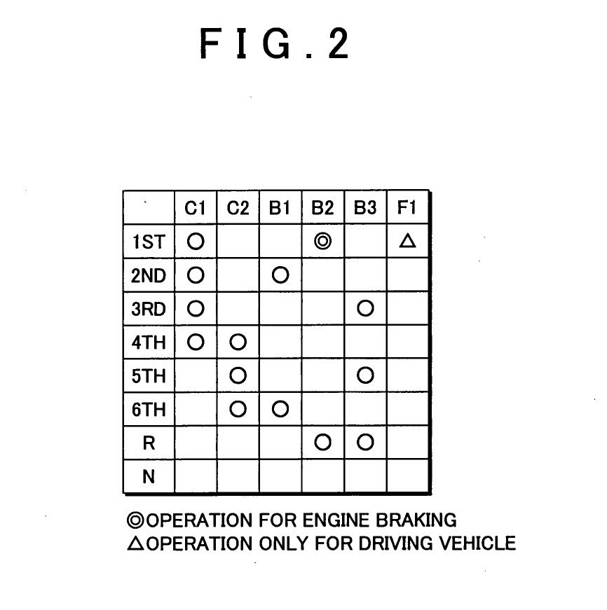

FIG. 1 is a schematic diagram of an automatic transmission 10 in a power transmission system 8 for a vehicle according to one embodiment of the invention. FIG. 2 lists various operating conditions of friction engagement elements or friction engagement devices when each of the gears is established. The automatic transmission 10 is used suitably for Front Engine, Front-wheel Drive (FF) vehicles, in which the transmission is disposed laterally. The automatic transmission 10 has a first transmission unit 14 and a second transmission unit 20 both on a common axis C in a transmission case 26 or a non-rotational member mounted to the vehicle body. The first transmission unit 14 includes a first single-pinion planetary gear train 12 as a main part. The second transmission unit 20 is a Ravigneaux-type transmission including a second double-pinion planetary gear train 16 and a third single-pinion planetary gear train 18 as a main part. The automatic transmission 10 varies rotation speed of an input shaft 22, which is output from an output rotational member 24. The input shaft 22 is equivalent to an input member of the invention. More specifically, the input shaft 22 is a turbine shaft of a torque converter 32 serving as a hydraulic power transmission driven by a driving power source or an engine 30 in this embodiment. Power output of the engine 30 is transmitted to a pair of drive wheels (not shown) through the torque converter 32, the automatic transmission 10, a differential gear (not shown) and a pair of driving axles. The automatic transmission 10 and the torque converter 32 have their approximately symmetrical counterparts with respect to the axis C. But, the schematic diagram of FIG. 1 does not show the lower half.

The torque converter 32 has a lockup clutch 34 serving as a lockup mechanism for directly transmitting power of the engine 30 to the input shaft 22 without fluid. The lockup clutch 34 is a hydraulic friction clutch designed to friction-engage by means of a difference between hydraulic pressures in an engagement-side oil chamber 36 and a disengagement-side oil chamber 38. Complete engagement of the lockup clutch 34 allows the direct transmission of the power of the engine 30 to the input shaft 22.

In the automatic transmission 10, one of six forward-drive gears from the first gear “1st” to the sixth gear “6th” and one reverse-drive gear “R” is established depending on a combination of the rotational elements of the first and second transmission units 14 and 20 (sun-gears S1 to S3, carriers CA1 to CA3 and ring gears R1 to R3). As shown in FIG. 2, the first to sixth forward-drive gears are established respectively by engagement of: a clutch C1 and a brake B2; the clutch C1 and a brake B1; the clutch C1 and a brake B3; the clutch C1 and a clutch C2; the clutch C2 and the brake B3; and the clutch C2 and the brake B1. In turn, the rearward-drive gear is established by engagement of the brakes B2 and B3. Releasing all the clutches C1, C2 and the brakes B1 to B3 provides a neutral condition.

The table of FIG. 2 lists the relationship between the aforementioned gears and the operating conditions of the clutches C1, C2 and the brakes B1 to B3. The circle indicates engagement while the double circle indicates engagement only for engine braking. More specifically, a one-way clutch F1 is arranged parallel to the brake B2 for establishing the 1st gear. Thus, via the one-way clutch F1, the clutch C1 alone engages for start-up (acceleration), otherwise the clutch C1 engages with the brake B2 for engine braking. Gear ratio of those gears is determined by each gear ratio p1, p2, p3 (the number of tooth of the sun gear divided by the number of tooth of the ring gear) of the first to third planetary gear trains 12, 16, 18.

As described above, in the automatic transmission 10 according to the embodiment of the invention, plural engagement devices or the clutches C1, C2 and the brakes B1 to B3 selectively engage to establish different gears with different gear ratios. As clearly seen from the table of FIG. 2, gear shifts are achieved using so-called clutch-to-clutch operation, in which any two of the clutches C1, C2 and brakes B1 to B3 simultaneously engage or disengage.

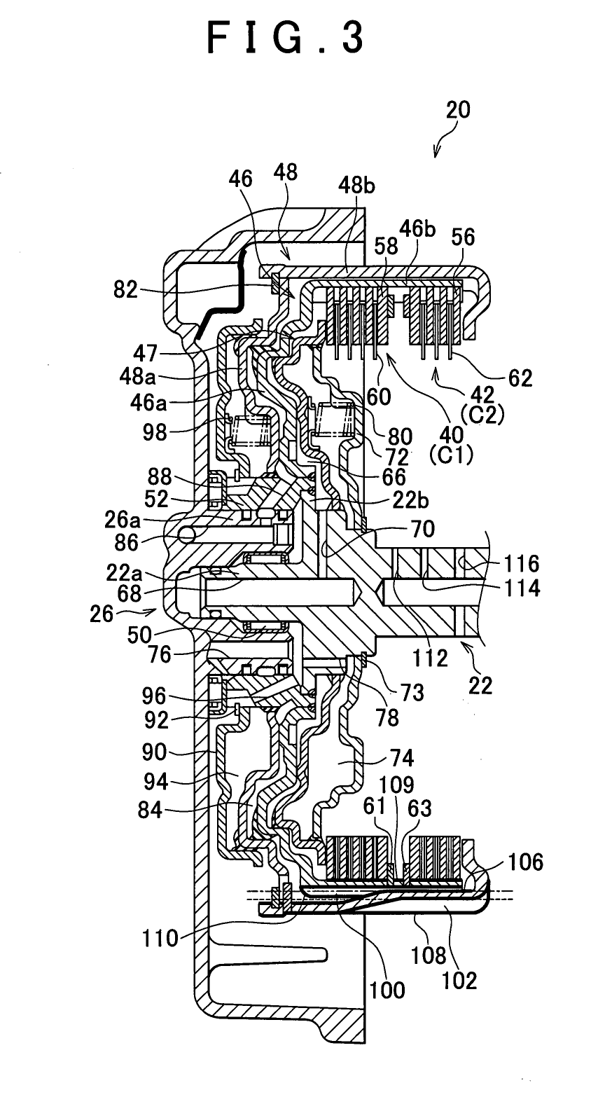

FIG. 3 is a sectional view illustrating an essential part of the second transmission unit 20 included in the automatic transmission 10. The second transmission unit 20 includes: a clutch drum 46; a first clutch piston 47; and a second clutch piston 48 which are all disposed to be rotatable coaxially about the input shaft 22. The clutch drum 46 is designed to support a first friction engagement element 40 that functions as the clutch C1 and a second friction engagement element 42 that functions as the clutch C2. The first clutch piton 47 is located inside the inner periphery of the clutch drum 46. The second clutch piston 48 is located to cover the outer periphery of the clutch drum 46. The second clutch piston 48 in this embodiment is equivalent to a pressure piston of the invention.

A rotational shaft or the input shaft 22 is supported by the transmission case 26 of the automatic transmission 10 through a bearing 50 so that the shaft 22 and the bearing 50 rotate relative to each other. The input shaft 22 includes an end 22a supported by the bearing 50 and a flange 22b located adjacent to the end 22a and protruding radially outward and perpendicular to the axis. The transmission case 20 in this embodiment is equivalent to a housing of the invention.

An outer peripheral edge of the flange 22b of the input shaft 22 is welded to one end of an annular member 52. The annular member 52 has an outside diameter approximately constant in the axial direction. The transmission case 26 includes an axially cylindrical portion 26a. The annular member 52 is fitted onto the outer peripheral surface of the axially cylindrical portion 26a so that they rotate relative to each other. In addition, an outer peripheral edge at the one end of the annular member 52 is welded to an inner peripheral edge of the clutch drum 46.

The clutch drum 46 is a cylindrical member having one axial end bottomed and the other end opened, that is, a bottom plate 46a and a cylindrical portion 46b. The bottom plate 46a has an approximately disk shape with its inner peripheral edge connected to the outer peripheral edge of the annular member 52, and extends outward radially in the vertical direction. The cylindrical portion 46b is connected to the outer peripheral edge of the bottom plate 46a. The flange 22b of the input shaft 22 and the bottom plate 46a are welded to the one end of the annular member 52, respectively, which allows the clutch drum 46 to rotate together with the input shaft 22.

The cylindrical portion 46b connected to the outer peripheral edge of the bottom plate 46a is a cylindrical member extending parallel to the axis. Plural inward-facing friction plates 56, which form the second friction engagement element 42, are spline-fitted on the inner peripheral surface of the clutch drum 46 near the opening thereof so that the friction plates 56 can move in the axial direction. In addition, plural inward-facing friction plates 58, which form the first friction engagement element 40 nearer the bottom plate 46a than the second friction engagement element 42 on the cylindrical portion 46b, are spline-fitted on the inner peripheral surface of the clutch drum 46, so that the friction plates 58 can move in the axial direction.

The first friction engagement element 40 includes the plural inward-facing friction plates 58, plural outward-facing friction plates 60 each interposed between the inward-facing friction plates 58, and a snap ring 61 fitted axially immovable onto the cylindrical portion 46b to prevent these friction plates 58, 60 from moving. The outward-facing friction plates 60 of the first friction engagement element 40 are spline-fitted on an outer peripheral surface of a rotational member (not shown). When the first friction engagement element 40 engages, rotations of the clutch drum 46 together with the input shaft 22 are transmitted to the sun gear S3 of the third planetary gear train 18 of FIG. 1 through the rotational member spline-fitted with the outward-facing clutch plates 60.

The second friction engagement element 42 includes the plural inward-facing friction plates 56, plural outward-facing friction plates 62 each interposed between the inward-facing friction plates 56, and a snap ring 63 fitted axially immovable onto the cylindrical portion 46b to prevent these friction plates 56, 62 from moving. The outward-facing friction plates 62 of the second friction engagement element 42 are spline-fitted on the outer peripheral surface of the ring gears R2, R3 of FIG. 1. When the second friction engagement element 42 engages, rotations of the clutch drum 46 together with the input shat 22 are transmitted to the ring gears R2, R3.

The first clutch piston 47 is designed to have an inner peripheral edge slidable in the axial direction through a seal member and an outer peripheral edge pressing the first friction engagement element 40. A hydraulic chamber 66 is defined between the first clutch piston 47 and the bottom plate 46a of the clutch drum 46. The hydraulic chamber 66 is supplied with hydraulic oil flowing through oil passages 68, 70 formed in the input shaft 22.

A partition 72 is disposed on the opposite side to the hydraulic chamber 66 with respect to the clutch piston 47. An inner periphery of the partition 72 is prevented from moving axially by a snap ring 73 fitted onto the input shaft 22, while an outer periphery of the partition 72 is fitted slidably onto the inner peripheral surface of the first clutch piston 47 through a seal member. This creates an oil-tight space or a centrifugal hydraulic pressure cancel chamber 74 between the first clutch piston 47 and the partition 72. The centrifugal hydraulic pressure cancel chamber 74 is supplied with hydraulic oil flowing through an oil passage 76 formed in the transmission case 26 and an oil passage 78 formed in the input shaft 22. The centrifugal hydraulic pressure cancel chamber 74 has a function of canceling hydraulic pressure produced by centrifugal force in the hydraulic chamber 66. A spring 80 is provided within the centrifugal hydraulic pressure cancel chamber 74 to urge the first clutch piton 47 toward the clutch drum 46.

Supplying hydraulic oil to the hydraulic chamber 66 generates propulsive force in the axial direction due to hydraulic pressure. Against the urging force of the spring 80, the first clutch piston 47 moves toward the partition 72 and thus the outer peripheral edge of the first clutch piston 47 presses the first friction engagement element 40. This brings the first friction engagement element 40 into engagement.

The second clutch piston 48 includes a disk-shaped bottom plate 48a and a cylindrical portion 48b connected to the outer peripheral edge of the bottom plate 48a to cover the clutch drum 46 from outside. The bottom plate 48a and the cylindrical portion 48b are fixed together with a snap ring 82.

The inner peripheral edge of the bottom plate 48a is fitted onto the outer peripheral surface of the annular member 52 with a seal member so that the bottom plate 48a can slide in the axial direction. A hydraulic chamber 84 is defined between the bottom plate 48a and the bottom plate 46a of the clutch drum 46. The hydraulic chamber 84 is supplied with hydraulic oil flowing through an oil passage 86 formed in the transmission case 26 and an oil passage 88 formed in the annular member 52.

A partition 90 is disposed on the opposite side to the hydraulic chamber 84 with respect to the clutch piston 48. An inner periphery of the partition 90 is prevented from moving axially by a snap ring 92 fitted onto the annular member 52, while an outer periphery of the partition 90 is fitted slidably onto a stepped portion of the bottom plate 48a of the second clutch piston 48 through a seal member. This creates an oil-tight space or a centrifugal hydraulic pressure cancel chamber 94 between the bottom plate 48a and the partition 90. The centrifugal hydraulic pressure cancel chamber 94 is supplied with hydraulic oil flowing through oil passages 76, 96 formed in the annular member 52. The centrifugal hydraulic pressure cancel chamber 94 has a function of canceling hydraulic pressure produced by centrifugal force in the hydraulic chamber 84. A spring 98 is provided within the centrifugal hydraulic pressure cancel chamber 94 to urge the second clutch piton 48 toward the clutch drum 46.

Supplying hydraulic oil to the hydraulic chamber 84 generates propulsive force in the axial direction due to hydraulic pressure. Against the urging force of the spring 98, the second clutch piston 48 moves toward the partition 90 and thus an end of the second clutch piston 48 presses the second friction engagement element 42. This brings the second friction engagement element 42 into engagement.

The cylindrical portion 46b of the clutch drum 46 has outer splines 100, while the cylindrical portion 48b of the second clutch piston 48 has inner splines 102, so that these splines are fitted with each other. This allows the clutch drum 46 and the second clutch piston 48 to rotate together.

Hydraulic oil is reserved at a vertical bottom of the transmission case 26. The hydraulic oil is used for a driving source that drives pistons, such as the first clutch piston 47 and the second clutch piton 48. It is also used as lubricant for various lubricated elements in the automatic transmission 10, such as meshing gears. An oil pump (not shown) draws the reserved hydraulic oil and therefore the level of the hydraulic oil varies all the time. According to the embodiment of the invention, while the automatic transmission 10 is reduced in size, the clutch drum 46 has the increased diameter in order to increase torque transmission capacity. This results in a slight distance between the clutch drum 46 and second clutch piston 48, and the surface of the reserved hydraulic oil. As the amount of hydraulic oil reserved increases, part of the clutch drum 46 and second clutch piston 48 are more likely to come into contact with the oil surface. Particularly, as the temperature of hydraulic oil increases, the oil viscosity decreases and accordingly, the oil adheres to the various lubricated elements for a shorter period of time. This results in a tendency that a larger amount of hydraulic oil circulates back to the reservoir, raising the oil level. The oil level may reach a broken line or dashed line shown in FIG. 3, for example. To be more specific, with the oil level shown by the broken line, a part of the cylindrical portion 48b of the second clutch piston 48 is in contact with the oil surface. In turn, with the oil level shown by the dashed line, a part of the cylindrical portion 48b of the second clutch piston 48 is immersed in hydraulic oil, while a part of the cylindrical portion 46b of the clutch drum 46 is in contact with the oil surface. It should be noted that although the respective oil levels shown by the broken and dashed lines vary in reality due to vibration or other factors, the both levels remain constant in this embodiment for the sake of better understanding. The hydraulic oil in the reservoir is equivalent to oil of the invention.

In this embodiment, the cylindrical portion 48b of the second clutch piston 48 has oil-repellent sections 106 and 108 respectively on its inner and outer peripheral surfaces, as shown by thick lines in FIG. 3. The oil-repellent sections 106 and 108 both are coated with fluorocarbon resin having oil repellent properties, typically polytetrafluoroethylene. In turn, the cylindrical portion 46b of the clutch drum 46 has oil repellent sections 109 and 110 respectively on its inner and outer peripheral surfaces, which are coated in the same manner as for the inner- and outer-peripheral oil-repellent sections 106 and 108. The outer splines of the clutch drum 46 and the inner splines of the second clutch piston 48 are fitted with each other having contact surfaces. However, except for these contact surfaces, other non-contact surfaces are subjected to oil repellent treatment. In other words, the oil repellent sections 106, 108, 109, 110 are provided on their respective surfaces where no power transmission members come into contact with. FIG. 3 solely shows that the oil repellent sections 106, 108, 109, 110 are provided at the vertical bottom, but in reality, each oil repellent section extends in the circumferential direction. The inner-peripheral oil-repellent sections 106, 109 and the outer-peripheral oil-repellent sections 108, 110 in this embodiment are equivalent to an oil repellent section of the invention.

In the automatic transmission 10 thus configured, when the input shaft 22 rotates at high speeds with the oil level shown by the broken line in FIG. 3, the inner- and outer-peripheral oil-repellent sections 106 and 108 of the cylindrical portion 48b of the second clutch piston 48 come into contact with the oil surface. Some hydraulic oil, which has adhered to these oil-repellent sections 106 and 108, tends to be repelled quickly due to the oil repellent properties thereof In this manner, hydraulic oil does not stay on the second clutch piston 48 for a long period of time, thereby reducing the rotational resistance to the second clutch piston 48 due to contact with the oil. Because hydraulic oil is repelled quickly, the amount of oil adhering to and rotating with the second clutch piston 48 decreases, thereby reducing oil heat generation that results from oil shear. As the clutch drum 46 and the second clutch piston 48 rotate at higher speeds, air resistance to these rotational members becomes higher. However, the air friction coefficient is lowered by means of the oil repellent sections 109, 110, resulting in some reduction in air resistance.

In turn, with the oil level shown by the dashed line in FIG. 3, the inner- and outer-peripheral oil-repellent sections 106 and 108 of the cylindrical portion 48b of the second clutch piston 48 come into contact with the oil surface, and so does the outer-peripheral oil-repellent section 110 of the clutch drum 46. Some hydraulic oil, which has adhered to these oil-repellent sections 106, 108, 110, tends to be repelled quickly due to the oil repellent properties thereof. In this manner, hydraulic oil does not stay on the second clutch piston 48 and the clutch drum 46 for a long period of time, thereby reducing the rotational resistance to the second clutch piston 48 and the clutch drum 46 due to contact with the oil. Because hydraulic oil is repelled quickly, the amount of oil adhering to and rotating with the second clutch piston 48 and the clutch drum 46 decreases, thereby reducing oil heat generation that results from oil shear.

Hydraulic oil used as lubricant splashes from oil passages 112, 114, 116, formed in the input shaft 22, radially outward to the second clutch piston 48 and the clutch drum 46 due to centrifugal force. The hydraulic oil passes through the lubricated elements, such as the first and second friction engagement elements 40, 42, and then adheres to the inner-peripheral oil-repellent section 109 of the cylindrical portion 46b of the clutch drum 46 as well as to the inner-peripheral oil-repellent section 106 of the second clutch piston 48. However, this hydraulic oil is repelled quickly due to the oil repellent treatment given on these inner-peripheral oil-repellent sections 106, 109. This prevents hydraulic oil from staying on the lubricated elements for a long period of time, so that the rotational resistance is reduced.

As described above, according to this embodiment of the power transmission system for a vehicle, the clutch drum 46 has the oil repellent section 110 on its outer peripheral surface. Thus, when the outer peripheral surface of the clutch drum 46 comes into contact with the surface of hydraulic oil, the oil repellent section 110 repels the oil quickly. Therefore, the amount of hydraulic oil, which adheres to and rotates with the clutch drum 46 agitating the oil, decreases. This reduces oil heat generation and the rotational resistance to the clutch drum 46.

In addition, according to this embodiment of the power transmission system for a vehicle, the second clutch piston 48 is disposed on the outer peripheral side of the clutch drum 46, and has the oil repellent sections 106 and 108 respectively on its inner and outer peripheral surfaces. Thus, when the inner and outer peripheral surfaces of the second clutch piston 48 come into contact with the surface of hydraulic oil, the inner- and outer-peripheral oil-repellent sections 106 and 108 repel the oil quickly. Therefore, the amount of hydraulic oil, which adheres to and rotates with the second clutch piston 48 agitating the oil, decreases. This reduces oil heat generation and the rotational resistance to the second clutch piston 48.

According to this embodiment of the power transmission system for a vehicle, the oil repellent sections 106, 108, 109, 110 are coated with polytetrafluoroethylene. This allows hydraulic oil, which has adhered to the clutch drum 46 and the second clutch piston 48, to be repelled quickly.

According to this embodiment of the power transmission system for a vehicle, hydraulic oil released from the input shaft 22 by centrifugal force adheres to the inner-peripheral oil-repellent section 109 of the clutch drum 46 and the inner-peripheral oil-repellent section 106 of the second clutch piston 48. However, these oil-repellent sections 106 and 109 can repel this hydraulic oil quickly. This prevents hydraulic oil from staying on the lubricated elements for a long period of time, so that the rotational resistance is reduced.

Although the embodiment of the invention has been discussed above in detail with respect to the drawings, other alternative embodiments may also be applicable to the invention.

For example, the power transmission system 8 for a vehicle in this embodiment is used suitably for FF vehicles. Alternatively, other types of vehicles, such as Front Engine, Rear-wheel Drive (FR) vehicle, may be applicable to the invention. In addition, the power transmission system 8 for a vehicle in this embodiment includes the automatic transmission 10. Alternatively, a power transmission system including a manual transmission may be applicable to the invention.

Further, the clutch drum 46 has the oil-repellant section 109 on its inner peripheral surface in this embodiment. Alternatively, the inner-peripheral oil-repellant section 109 may not be needed for carrying out the invention. This is because, although some lubricant, released from the input shaft 22, adheres to the inner-peripheral oil-repellant section 109, the adhesion amount is smaller than those of the other oil-repellant sections 106, 108, 110 due to non-contact with the hydraulic oil reserved at the bottom of the transmission case 26.

The oil-repellant sections 109, 106, 110, 108, are provided respectively on the inner and outer peripheral surfaces of the clutch drum 46 and the second clutch piston 48 in this embodiment. Alternatively, an oil-repellant section may be provided to other sections that can rotate at high speeds and contact hydraulic oil, such as the partitions 72, 90 and the bottom plates 46a, 48a. Thus, other rotational members may also obtain the effects of the invention. For example, a counter gear or differential gear disposed in the power transmission system 8 for a vehicle may also obtain the effects of the invention, even if the outer peripheral section of such gear tends to contact the oil surface. It should be noted that because such outer peripheral section has a portion that is easily worn by the contact with any other power transmission members, another portion of the outer peripheral section that does not contact the other power transmission members need be subjected to oil-repellent treatment.

Further, oil repellent treatment is given on both the inner and outer peripheral surfaces of the cylindrical portion 46b of the clutch drum 46 and the cylindrical portion 48b of the second clutch piston 48 in this embodiment. Alternatively, either one of the inner and outer peripheral surfaces, or only a part the surface in the circumferential direction may be subjected to oil-repellent treatment to obtain the satisfactory effects of the invention.

Further, the oil-repellent sections 106, 108, 109, 110 are provided for the clutch drum 46 and the second clutch piston 48 in this embodiment. Alternatively, such oil-repellent section may be provided on surfaces of other rotated members, such as a torque converter, flywheel, clutch disk, crankshaft and balancer, to obtain the effects of the invention as described above. More specifically, it would be desirable that hydraulic oil may be isolated from the rotated members immediately after the oil has lubricated the rotated members. Such rotated members subjected to oil-repellent treatment repel hydraulic oil quickly, thereby reducing rotational resistance to the rotated members.

The oil-repellent section is coated with polytetrafluoroethylene, which is a typical of fluorocarbon resin having repellent properties, in this embodiment. Alternatively, another type of fluorocarbon resin, such as polychlorotrifluoroethylene, may be used. To achieve the effects of the invention, other substances or materials may be alternatively used as long as it has oil-repellent properties. This includes any substances having a weak affinity for oil or a hydrophilic group on the surface thereof, as well as a specific surface-active agent and a DLC coating.

The above exemplary embodiment is merely intended to be illustrative. Various modifications and improvements may be made to the embodiment based on the knowledge of persons skilled in the art.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A power transmission system for a vehicle comprising:
a housing that can reserve oil therein; and
a rotational member rotatably supported within the housing, with a surface of the rotational member being partly contactable with a surface of the oil reserved in the housing, wherein
the surface of the rotational member partly contactable with the oil surface includes a non-contact surface that is not in contact with any power transmission members, the non-contact surface having an oil repellent section.

2. The power transmission system for a vehicle according to claim 1, wherein
the rotational member is a clutch drum, and the clutch drum has the oil repellent section on the outer peripheral surface thereof.

3. The power transmission system for a vehicle according to claim 2, wherein
a pressure piston is disposed on the outer peripheral side of the clutch drum to press a friction engagement element supported by the clutch drum, and the pressure piston has the oil repellent section on the outer peripheral surface thereof.

4. The power transmission system for a vehicle according to claim 3, wherein
the pressure piston is disposed on the outer peripheral side of the clutch drum to press the friction engagement element supported by the clutch drum, and the pressure piston has the oil repellent section on the inner peripheral surface thereof.

5. The power transmission system for a vehicle according to claim 2, wherein
the clutch drum has the oil repellent section on the inner peripheral surface thereof.

6. The power transmission system for a vehicle according to claim 5, wherein
the pressure piston is diposed on the outer peripheral side of the clutch drum to press the friction engagement element supported by the clutch drum, and the pressure piston has the oil repellent section on the outer peripheral surface thereof.

7. The power transmission system for a vehicle according to claim 5, wherein
the pressure piston is disposed on the outer peripheral side of the clutch drum to press the friction engagement element supported by the clutch drum, and the pressure piston has the oil repellent section on the inner peripheral surface thereof.

8. The power transmission system for a vehicle according to claim 1, wherein the oil repellent section is coated with polytetrafluoroethylene.

9. The power transmission system for a vehicle according to claim 1, wherein the oil repellent section is coated with polychlorotrifluoroethylene.
